(19) United States
(12) Patent Application Publication
(10) Pub. No.: US 2025/0294409 A1
(43) Pub. Date: Sep. 18, 2025

(54) OPTIMIZED INNOVATIVE ALGORITHM FOR BLUETOOTH LOW ENERGY (BLE) HIGH ACCURACY DISTANCE MEASUREMENT (HADM) FOR INDOOR APPLICATIONS

(71) Applicant: HEWLETT PACKARD ENTERPRISE DEVELOPMENT LP, Spring, TX (US)

(72) Inventors: AHMAD YACOUB, Spring, TX (US); Todd Moy, Spring, TX (US); Farhan HASNAIN, Santa Clara, CA (US)

(21) Appl. No.: 18/605,560

(22) Filed: Mar. 14, 2024

(51) Int. Cl. H04W 28/20; H04L 5/00; H04W 72/0453

(52) U.S. Cl. CPC H04W 28/20; H04L 5/0048; H04W 72/0453

(57) ABSTRACT

Systems and methods for locating a client device in a network using Bluetooth® Low Energy (BLE) is described herein. Upon determining an access point (AP) connected to the client device, an antenna of a network device may be selected based on an antenna polarization of the client device. A first and second channel frequencies for the client device may be selected. A first and second phase measurements may be determined based on the first and second channel frequencies. A distance of the client device from the AP may be determined according to a frequency difference between the first and second channel frequencies and a phase difference between the first and second phase measurements. An angle of direction of the client device to the AP may be determined. A location of the client device may be determined according to the distance and the angle of direction.

### BACKGROUND

Wi-Fi® is a wireless networking protocol that allows a device to interface with the internet or with other nearby devices using radio waves. An access point (AP) is a networking device that allows Wi-Fi®-enabled devices (wireless devices) to connect to a wired network. An AP forms a wireless local-area network (WLAN) and acts as a central transmitter and receiver of wireless radio signals between wireless devices. A plurality of APs may be available within a given area, and each AP may be positioned in a different location within the given area.

Bluetooth® is a technology useful for data transfers between devices. Bluetooth® Low Energy (BLE) is a wireless personal area network technology that is designed to provide many of the same features as Bluetooth®, but with reduced power consumption and cost while still maintaining similar communication ranges. Various measuring methods may be used in BLE to measure the distance between Bluetooth®-enabled devices. Such measuring methods include the Received Signal Strength Indicator (RSSI) method (around 3-5 meter accuracy), the Angle of Arrival (AoA)/Angle of Departure (AoD) method, and the High Accuracy Distance Measurement (HADM) method. These measuring methods each have a resolution (i.e., margin of error) in the accuracy of measuring distance (RSSI has a resolution of around 3-5 meter accuracy, AoA/AoD has a resolution of around 50 cm accuracy, and HADM has a resolution of around 10 cm accuracy).

Currently, the use of such measuring methods in locating a Bluetooth® enabled device is limited based on the network configuration and environment, such that there needs to be a minimum number of APs in the network available to perform measurements. This may lead to problems with devices being able to locate other devices in a network to establish communication connections when the network configuration and environment is unaccommodating. There is a need to perform one or more measuring methods, such as HADM, to locate a Bluetooth®-enabled device regardless of the network configuration and environment, to enable users to locate other devices and enable communication connections to be more easily established.

### BRIEF DESCRIPTION OF THE DRAWINGS

The present disclosure, in accordance with one or more various examples, is described in detail with reference to the following figures. The figures are provided for purposes of illustration only and merely depict typical or example examples. These illustrative examples are mentioned not to limit or define the disclosure, but to provide examples to aid understanding thereof. Additional examples are discussed in the Detailed Description, and further description is provided there.

FIG. 1 is an illustration of an example computing system of a network for locating a client device using Bluetooth® Low Energy (BLE), in accordance to various examples described in the present disclosure.

FIG. 2 is an illustration of an example computing system of a network for locating a client device using BLE, in accordance to various examples described in the present disclosure.

FIG. 3 is an illustration of an example network device for communicating with a client device using two sets of antennas, in accordance to various examples of the present disclosure.

FIG. 4 is an illustration of an example diagram for locating a client device by performing High Accuracy Distance Measurement (HADM), in accordance to various examples of the present disclosure.

FIG. 5 is an illustration of an example diagram for locating a client device by performing HADM, in accordance to various examples of the present disclosure.

FIG. 6 is an illustration of an example computing component that includes one or more hardware processors and machine-readable storage media storing a set of machine-readable/machine-executable instructions that, when executed, cause the one or more hardware processors to perform an illustrative method for locating a client device by performing HADM, in accordance to various examples of the present disclosure.

FIG. 7 illustrates a block diagram of an example computer system in which various examples of the present disclosure may be implemented.

The figures are not exhaustive and do not limit the present disclosure to the precise form disclosed.

### DETAILED DESCRIPTION

High Accuracy Distance Measurement (HADM) may be used to locate a Bluetooth®-enabled device by determining the distance of the Bluetooth®-enabled device in relation to one or more access points (APs). HADM uses channel sounding techniques using two Bluetooth® Low Energy (BLE) channel frequencies of a Bluetooth®-enabled device in connection with an AP. HADM also relates the frequency difference between the BLE channel frequencies with phase difference which can give a distance calculation of up to 75m of unambiguous range between the AP and the Bluetooth®-enabled device. The result would be a circular distance of radius (R) around the AP that represents the possible position of the Bluetooth®-enabled device in relation to the AP. Choosing the two BLE channel frequencies for the Bluetooth®-enabled device is important in optimizing the maximum range vs the resolution (i.e., margin of error) for determining HADM measurements. As the delta (i.e., difference) between the two channel frequencies of the Bluetooth®-enabled device increases, the maximum achievable range between the AP and the Bluetooth®-enabled device decreases with the resolution also decreasing (i.e., improves with less percentage of error). Alternatively, as the delta between the two channel frequencies of the Bluetooth®-enabled device decreases, the maximum achievable range between the AP and the Bluetooth®-enabled device increases with the resolution also increasing (i.e., worsens with greater percentage of error).

Currently, HADM may be used to locate a Bluetooth®-enabled device when there are at least two neighboring APs surrounding the Bluetooth®-enabled device that are within a Line of Sight (LoS) of a main AP that the Bluetooth®-enabled device is connected to. This particular method of using HADM on a main AP and two surrounding APs is considered the AP Trilateration method. Unfortunately, the AP Trilateration method is limited in use because it requires two surrounding LoS APs relative to a main AP connected to a Bluetooth®-enabled device. Being able to apply HADM under any network configuration and setting may be beneficial in locating devices faster and more accurately. Moreover, being able to apply HADM irrespective of the network configuration and settings may enable users to more easily identify and establish communication connections with other devices that are within close proximity.

Being able to apply HADM to various device locating methods may allow a locating system to choose the optimal device locating method that utilizes HADM to locate devices, based on network configurations and environmental surroundings. Examples of the present disclosure provide a solution, whereby an algorithm can be used to select from different methods that apply or leverage HADM to locate a Bluetooth®-enabled device, including the AP Trilateration method and an alternative locating method that only requires the use of information associated with a main AP connected to the Bluetooth®-enabled device. In this way, the optimal locating method to locate a Bluetooth®-enabled device may be used depending on the network configuration, allowing the location of a Bluetooth®-enabled device to be determined irrespective of the mapping of APs in an enterprise.

Examples of the disclosure may provide systems and methods configured to locate client devices in a network. Such client devices may be Bluetooth®-enabled devices that include Bluetooth® features, such as Bluetooth® Low Energy (BLE). To locate a client device, a locating system may use a network device, such as a radio chip, to perform the optimal locating method to locate the client device. The network device may include at least two cores, each with at least two separate antennas. A first core may be used for HADM application, while a second core can be used for either an Internet of Things (IoT) application or for an Angle of Arrival/Angle of Departure (AoA/AoD) method, depending on the mapping of APs in the enterprise. Both cores may have the same phase length at their respective antenna connectors, or at least each core may be phase calibrated to have the same initial phase at their respective antennas. The locating system may use an algorithm to determine the optimal locating method according to the network configuration and use the network device to perform the optimal locating method to locate a client device.

In one example, if it is determined that a main, locating AP has two or more surrounding APs in its line of sight (LOS), the locating system may select antenna(s) of the first core of the network device to be used for HADM application based on the client device's antenna polarization (i.e., a vertical antenna of the first core may be selected for a vertical antenna of the client device and a horizontal antenna of the first core may be selected for a horizontal antenna of the client device). The second core of the network device can be used for IoT applications. The locating system may then implement the AP Trilateration locating method using HADM to determine the location of the client device based on determined distances of the client device from each of the main AP and the surrounding LOS APs. For example, the client device may be located at any position around the main, locating AP that is of the determined distance of the client device from the main, locating AP (i.e., the result may be a circular distance of radius (R) around the main, locating AP, with the radius being the determined distance and the circular distance representing the possible positions of the client device in relation to the main, locating AP). The client device may also be located at any position around a first of the LoS APs that is of the determined distance of the client device from the first of the LOS APs. The client device may further be located at any position around a second of the LOS APs that is of the determined distance of the client device from the second of the LOS APs. Using the circular distance of each AP (i.e., the main AP and both LOS APs), the location of the client device may be determined as the point of intersection of the three circular distances.

In another example, if it is determined that the main, locating AP does not have two or more surrounding APs in LoS, then the locating system may select the first core of the network device to use HADM to determine a distance of the client device from the main, locating AP. Antenna(s) of the first core of the network device may be selected based on the client device's antenna polarization (i.e., a vertical antenna of the first core may be selected for a vertical antenna of the client device and a horizontal antenna of the first core may be selected for a horizontal antenna of the client device). The client device may be located at any position around the main, locating AP that is of the determined distance of the client device from the main AP (i.e., the result may be a circular distance, with a radius of the determined distance, around the main, locating AP that represents the possible positions of the client device in relation to the main, locating AP). Upon determining the distance of the client device and generating the circular distance, the locating system may use the network device to apply at least one of the AoA method on at least one core with at least two antennas or the AoD method on at least one core with at least two antennas to determine the client device's directions in transmitting signals to (i.e., AoD direction) and receiving signals from (i.e., AoA direction) the main, locating AP, respectively. Antenna(s) of the first and second cores of the network device may be selected based on the client device's antenna polarization (i.e., vertical antennas of the first core and the second core may be selected for a vertical antenna of the client device and horizontal antennas of the first and second cores may be selected for a horizontal antenna of the client device). In this example, both cores of the network device may be phase calibrated and the antenna polarization on the cores of the network device may be selected to be the same as the client device's antenna polarization. Using the circular distance of the client device and at least one of the AoA direction or the AoD direction, the locating system may determine the location of the client device. In this way, the location of a client device may be determined regardless of the environmental surroundings of an AP in an enterprise and a locating system may determine the optimal locating method to locate a client device depending on the network configuration.

The present disclosure provides a solution to a technical problem rooted in computer technology regarding the limited ability for a network to locate the position of devices, in particular when the network has unfavorable configurations and attributes. The present disclosure may enable a network to locate any client device irrespective of the network configuration and attributes, including a lack of internet or Wi-Fi®. The present disclosure may process and implement computationally large and complex data using various computer algorithms, programs, and applications simultaneously, providing faster and more accurate determinations in locating devices in a network.

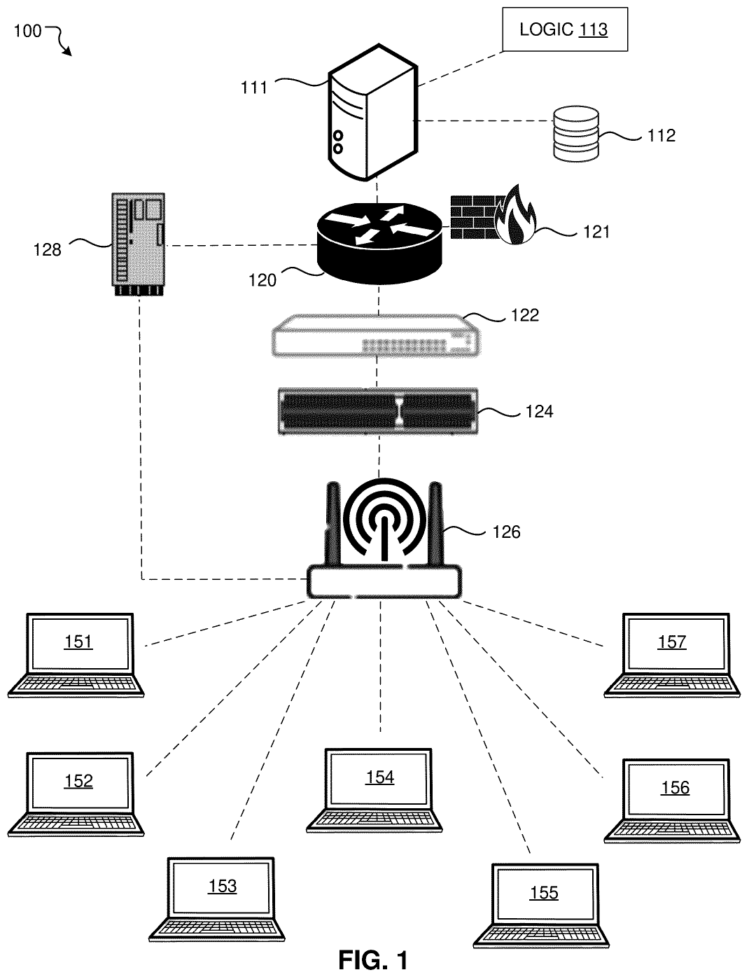

FIG. 1 is an illustration of an example computing system 100 including one or more computing components that may encompass any of a server 111, a router 120, a switch 122, a network controller 124, an access point (AP) 126, and a DHCP server 128. In some examples, the router 120 may be associated with a firewall 121. The server 111 may further include or be associated with a database or cache 112 (hereinafter “database”) which stores attributes of particular client devices and access control lists or policies associated with particular client devices, such as client devices 151-157, which connect to a network via the access point 126. In some examples, any or all of the client devices 151-157 may include plug and play devices. Although only seven client devices are illustrated in FIG. 1, any number of client devices may be connected via the access point 126. The database 112 may be integrated or embedded within the server 111 or spatially separated from the server 111. The access control lists may be stored as files and/or may be indexed. In some examples, the access control lists or policies may include particular access levels and/or access privileges to be assigned to each client device depending on a group or classification that the client device belongs to. For example, the access privileges may indicate a subset (e.g., a portion or all) of data resources, such as particular data servers, databases, platforms, objects, file directories, or files that each client device is authorized to access, particular protocols (e.g., Hypertext Transfer Protocol (HTTP) or File Transfer Protocol (FTP)) that each client device may utilize to access data resources, a transmission speed or rate to be provided to each of the client devices, one or more Vendor Specific Attributes (VSA), and/or a particular VLAN to be assigned to each client device. In some examples, the VSA may include bandwidth on incoming and/or outgoing traffic, and download and/or upload speeds. The access control lists or policies may be stored in the database 112 of the server 111, rather than at other computing components such as the router 120, so that the server 111 may centrally update the access control lists or policies and propagate any updates to other computing components in the network.

In some examples, the client devices 151-157 can access the internet, wirelessly, through Wi-Fi® (e.g., IEEE 802.11), Bluetooth® (e.g., IEEE 802,15,1), or cellular connection (e.g., long-term evolution, 5th generation cellular networks, etc.) to wirelessly access the server 111 through the access point 126. The server 111 can implement software and/or hardware, such as web servers, application server, communications server, database server, etc. The server 111 can access the internet through Wi-Fi®, Bluetooth®, phone line, or LAN/WLAN network interface. In other examples, the access point 126 can be an enterprise intranet (e.g., a private network) and the client devices 151-157 can access the enterprise intranet, wirelessly, through the access point 126 to access data files or other enterprise data. In some cases, the access point 126 can be a network link (e.g., Wi-Fi®, Ethernet port, router, switch, etc.) that allows a plurality of computing components to communicate with each other. The network controller 124 and the access point 126 can be configured to allow computing components in a network such as the client devices 151-157 and the server 111 to connect. In some examples, the access point 126 can establish a client-client communication between the client devices 151-157.

Each of the computing components may include one or more hardware processors and logic that implements instructions to carry out the functions of the computing components. The server 111 may include or be associated with one or more hardware processors and logic 113 that implements instructions or protocols to carry out the functions of the server 111. The logic 113 may execute instructions to retrieve identification information and attributes of a client device. The logic 113 may execute instructions to select a first and second channel frequencies. The logic 113 may execute instructions to determine a first and second phase measurements. The logic 113 may execute instructions to determine a distance of a client device from the access point 126. The logic 113 may execute instructions to determine an angle of arrival (AoA) direction of the client device to the access point 126. The logic 113 may execute instructions to determine an angle of departure (AoD) direction of the client device to the access point 126. The logic 113 may execute instructions to determine a location of the client device.

The logic 113 may be associated to the AP 126. The logic 113 may instruct the AP 126 to execute instructions to select the first and second channel frequencies. The AP 126 may execute instructions to determine the first and second phase measurements. The AP 126 may execute instructions to determine the distance of the client device from the AP 126. The AP 126 may execute instructions to determine the AoA direction of the client device to the AP 126. The AP 126 may execute instructions to determine an AoD direction of the client device to the AP 126. The AP 126 may execute instructions to determine the location of the client device.

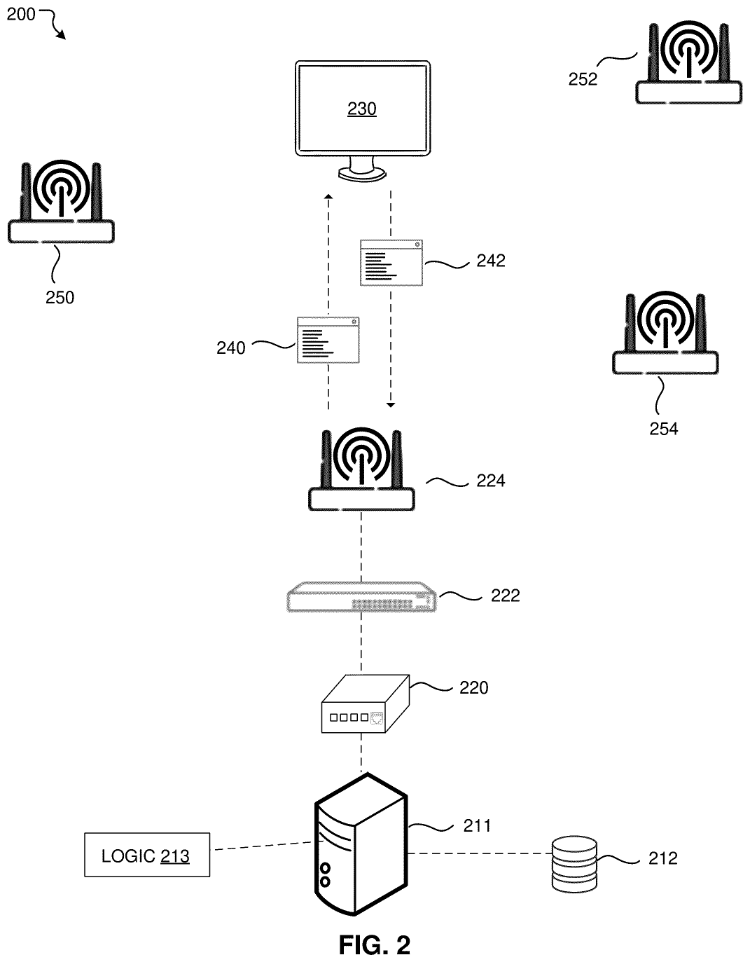

FIG. 2 is an illustration of an example computing system of a network 200 over which locating client devices using High Accuracy Distance Measurement (HADM) is implemented in accordance with various examples of the present disclosure. In some examples, the network 200 can comprise or include one or more computing components that may encompass any of the server 211, a network device 220, a network controller 222, access points 224, 250, 252, and 254, and client device 230. FIG. 2 elaborates on specific components of FIG. 1 while elucidating an exchange of information among the components. The client device 230 can be any of computing devices, such as computers, mobile phones, tablet devices, etc. The network device 220 may be implemented as the router 120 or switch 122 of FIG. 1. The network device 220 can be a router or a switch that is configured to connect various computing components in a network, such as the client device 230, the network controller 222, the access point (AP) 224, and the server 211. The server 211 may further include or be associated with the database or cache 212 (hereinafter “database”) which stores attributes of particular client devices, servers, and access control lists or policies associated with the client devices 230, which connect to a network via the access point 224. In some examples, the client devices 230 can access the internet, wirelessly, through Wi-Fi® (e.g., IEEE 802.11), Bluetooth® (e.g., IEEE 802,15,1), or cellular connection (e.g., long-term evolution, 5th generation cellular networks, etc.) to wirelessly access the server 211 through the network device 220. The server 211 can implement software and/or hardware, such as web servers, application server, communications server, database server, etc. The server 211 can access the internet through Wi-Fi®, Bluetooth®, phone line, or LAN/WLAN network interface. In other examples, the network device 220 can be an enterprise intranet (e.g., a private network) and the client devices 230 can access the enterprise intranet, wirelessly, through the network device 220 to access data files or other enterprise data. In some cases, the network device 220 can be a network link (e.g., Wi-Fi®, Ethernet port, router, switch, etc.) that allows a plurality of computing components to communicate with each other. The network controller 222 and the access point 224 can be configured to allow computing components in a network such as the client device 230 and the server 211 to connect through the network device 220. In this example, the network device 220 can establish a client-client communication connection between the client device 230 and other client devices.

In some examples, a client device 230 may establish a communication connection with the network device 220, the access point 224, and one or more other client devices. The client device 230 may receive and send transmission packet, such as packets 240 and 242, to the network device 220. The packet 242 may include identification information and attributes of the client device 230. The network device 220 may use server 211 to implement one or more operations. The network device 220 may determine if there are at least two APs surrounding AP 224, such as APs 250, 252, and 254. The network device 220 may determine if there are at least two surrounding APs that are in a line of sight (LOS) relative to AP 224. If it is determined that there are less than two APs surrounding AP 224 or there are less than two surrounding APs that are in a LOS relative to AP 224, then the network device 220 may select at least one core with at least two antennas to use HADM to determine a distance of the client device 230 from AP 224. The antennas of the core of the network device 220 may be selected based on the antenna polarization of the client device 230 (i.e., a vertical antenna of the core of the network device 220 may be selected for a vertical antenna of the client device 230 and a horizontal antenna of the core of the network device 220 may be selected for a horizontal antenna of the client device 230).

The network device 220 may select a first and second channel frequencies for the client device 230. The network device 220 may send instructions to the AP 224 to perform HADM to determine the location of the client device 230. Based on the instructions received from the network device 220, the AP 224 may use the first and second channel frequencies to determine a first and second phase measurements. The AP 224 may determine a frequency difference between the first and second channel frequencies and a phase difference between the first and second phase measurements. The AP 224 may use the frequency difference and the phase difference to determine a distance of the client device 230 from the AP 224. The AP 224 may determine at least one of an angle of arrival (AoA) direction or an angle of departure (AoD) direction of the client device 230 to the AP 224. The AoA direction or the AoD direction of the client device 230 may be determined based on messages received or transmitted using at least two separate antennas of AP 224 to the client device 230. The AP 224 may use the distance and at least one of the AoA direction or AoD direction of the client device 230 to determine a location of the client device 230. The AP 224 may determine the location of the client device 230 by generating a location circle with a radius of the distance of the client device 230 around AP 224, with the location circle being indicative of potential locations of the client device 230 with respect to AP 224. The AP 224 may further determine an AoA location on the location circle based on the AoA direction of the client device 230 to AP 224 or an AoD location on the location circle based on the AoD direction of the client device 230 to AP 224. The location of the client device 230 may be either the AoA location or the AoD location on the location circle. The server 211 may store the identification information and attributes of the client device 230 in a database, such as database 212. The server 211 may store the distance, AoA direction, AoD direction and location of the client device 230 in database 212.

If it is determined that there are at least two APs surrounding AP 224 and at least two surrounding APs are in a LOS relative to AP 224, then the network device 220 may select two surrounding LOS APs, such as APs 250 and 254. The network device 220 may select a first and second channel frequencies for the client device 230. The network device 220 may instruct each of the LOS APs and AP 224 to perform HADM to determine the location of the client device 230. Each of the LoS APs and AP 224 may use the first and second channel frequencies to determine their respective first and second phase measurements. Each of the LOS APs and AP 224 may determine their respective frequency difference between the first and second channel frequencies and their respective phase difference between the first and second phase measurements. The AP 224 may use its respective frequency difference and its respective phase difference to determine a distance between the client device 230 and AP 224. The LOS AP 250 may use its respective frequency difference and its respective phase difference to determine a distance between the client device 230 and AP 250. The Los AP 254 may use its respective frequency difference and its respective phase difference to determine a distance between the client device 230 and AP 254. The network device 220 may use the distances of the client device 230 from APs 224, 250, and 254 to determine the location of the client device 230. The location of the client device 230 may be determined by using the distance of each AP from client device 230 to create a location circle around each AP with the radius of each location circle being each AP's respective distance, and the intersection of the three AP's location circles may indicate the location of the client device 230.

In this way, the network device 220 may determine the location of a client device, such as client device 230, regardless of the number of access points surrounding and in a LoS to the access point connected to the client device, such as AP 224.

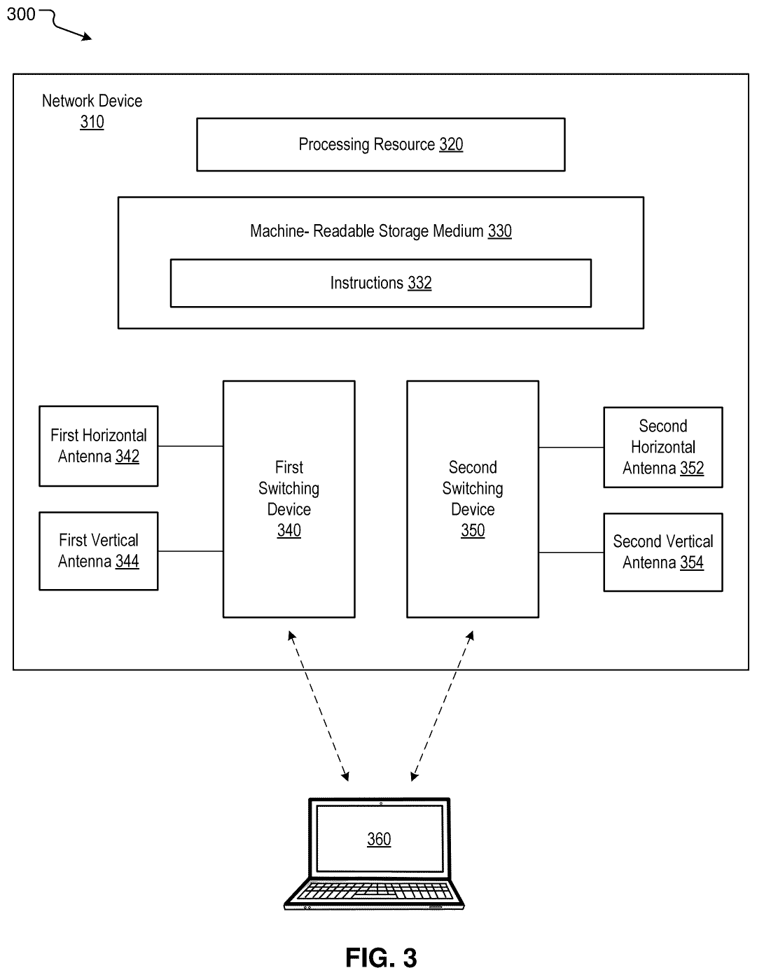

FIG. 3 illustrates an example of a network 300 over which High Accuracy Distance Measurement (HADM) of a client device may be performed in accordance with various examples of the present disclosure. In some examples, the network 300 may include a network device 310 and a client device 360. The client device 360 can be any computing device, such as a computer, mobile phone, tablet device, etc. The network device 310 may be implemented as an access point, router or switch. The network device 310 may also be implemented as an Access Point (AP) multi-link device (MLD). The network device 310, in some examples, can be involved in a plurality of different client-server communications, including with client device 360, on which a plurality of sessions can occur simultaneously. The network device 310 may include a processing resource 320 and a machine-readable medium 330. The machine-readable medium 330 may include (i.e., encoded with) instructions 332 that are executable by the processing resource 320 of the network device 310 to implement functionalities described herein in relation to instructions 332.

While not shown in FIG. 3, the network device 310 may be configured to connect various computing components in a network, such as one or more client devices, including client devices (e.g., client devices 360, 151-157, and 230), a network controller (e.g., network controller 124, 222), an access point (e.g., access point 126, 224), and a server (e.g., server 111, 211). The server may include or be associated with a database or cache (hereinafter “database”) which stores attributes of particular client devices, servers, and access control lists or policies associated with the client device 360, which connect to the network 300 via the access point. In some examples, the client device 360 can access the internet, wirelessly, through Wi-Fi® (e.g., IEEE 802.11), Bluetooth® (e.g., IEEE 802,15,1), or cellular connection (e.g., long-term evolution, 5th generation cellular networks, etc.) to wirelessly access the server through the network device 310. The server can implement software and/or hardware, such as web servers, application server, communications server, database server, etc. The server can access the internet through Wi-Fi®, Bluetooth®, phone line, or LAN/WLAN network interface. In other examples, the network device 310 can be an enterprise intranet (e.g., a private network) and the client device 360 can access the enterprise intranet, wirelessly, through the network device 310 to access data files or other enterprise data. In some cases, the network device 310 can be a Bluetooth® Low Energy (BLE) radio chip that allows a plurality of computing component to communicate with each other. In other cases, the network device 310 can be a network link (e.g., Wi-Fi®, Ethernet port, router, switch, etc.) that allows a plurality of computing components to communicate with each other. The network controller and the access point can be configured to allow computing components in a network such as the client device 360 and the server to connect through the network device 310. In some examples, the network device 310 can be used to locate other devices in the network 300, such as client device 360. In other examples, the network device 310 can establish a client-client communication between the client device 360 and other client devices.

In the example of FIG. 3, the network device 310 may engage in any network data transmission operations, including, but not limited to, switching, routing, bridging, or a combination thereof. In some examples, network device 310 may comprise a wireless access point (WAP). In examples described herein, a “WAP” generally refers to receiving points for any known or convenient wireless access technology which may later become known. Specifically, the term WAP is not intended to be limited to WAPs which conform to IEEE 802.11 standards. A WAP generally functions as an electronic device that is adapted to allow wireless devices to connect to a wired network via various communications standards. A WAP may include any necessary hardware components to perform examples of the technology/ies disclosed herein, including, but not limited to: processors, memories, display devices, input devices, communications equipment, etc. It should be understood by one of ordinary skill in the art that network device 310 may be any suitable type(s) of network devices made by any suitable manufacturer(s).

In the example of FIG. 3, network device 310 may include a first switching device 340, first horizontal antenna 342, first vertical antenna 344, second switching device 350, second horizontal antenna 352, and second vertical antenna 354. In some examples, first switching device 340 may be connected to the first horizontal antenna 342 and first vertical antenna 344, and second switching device 350 may be connected to the second horizontal antenna 352 and second vertical antenna 354. In some examples, first switching device 340 may include one or more switches which are connected to one or more of the first horizontal antenna 342 and first vertical antenna 344, and the second switching device 350 may include one or more switches which are connected to one or more of the second horizontal antenna 352 and second vertical antenna 354. In some examples, first switching device 340 may include one or more filters which are connected to one or more of first horizontal antenna 342 and first vertical antenna 344, and the second switching device 350 may include one or more filters which are connected to one or more of the second horizontal antenna 352 and second vertical antenna 354.

In some examples, each of the first vertical antenna 344, second switching device 350, second horizontal antenna 352, and second vertical antenna 354 may operate at one or more frequency bands which conform one or more IEEE standards (e.g., 802.11ax). In some examples, the first vertical antenna 344, second switching device 350, second horizontal antenna 352, and second vertical antenna 354 may operate at one or more frequency channels in the 2.4 GHz frequency band. In some examples, the first vertical antenna 344, second switching device 350, second horizontal antenna 352, and second vertical antenna 354 may operate at one or more frequency channels in the 5 GHz frequency band. In some examples, the first vertical antenna 344, second switching device 350, second horizontal antenna 352, and second vertical antenna 354 may operate at one or more frequency channels in the 6 GHZ frequency band. It will be understood by one skilled in the art that the first vertical antenna 344, second switching device 350, second horizontal antenna 352, and second vertical antenna 354 may operate at any suitable frequency band(s) and conform to any suitable type(s) of wireless communication standards, now known and later developed. Moreover, although FIG. 3 shows network device 310 comprising two switching devices and four antennas (two horizontal and two vertical), it should be understood by one skilled in the art that network device 310 may comprise any suitable number of switching devices and antennas.

In some examples, each of the first vertical antenna 344, second switching device 350, second horizontal antenna 352, and second vertical antenna 354 may transmit and/or receive directional signals, omnidirectional signals, or a combination thereof. In examples described herein, a “directional” signal refers to a signal which radiates more strongly in one or more directions as compared to one or more other directions along an azimuth plane (i.e., horizontal plane), whereas an “omnidirectional” signal refers to a signal which radiates equally in all directions along an azimuth plane. In some examples, each antenna may comprise a phased array antenna. In examples described herein, a “phased array antenna” refers to an array of antennas which can create a directional signal which can be electronically steered to point in different directions without moving the antennas. In such examples, a phased array antenna may comprise an array of directional and/or omnidirectional antennas which can focus RF energy towards specific spatial directions. It will be understood by one skilled in the art that an antenna may comprise any suitable type(s) of antenna, now known and later developed. Moreover, although FIG. 3 shows network device 310 comprising four antennas, it should be understood by one skilled in the art that network device 310 may comprise any suitable number of antennas.

In some examples, the network device 310 may be used to locate a client device, such as, for example, client device 360 in the network 300 using High Accuracy Distance Measurements (HADM). Client device 360 may be a Bluetooth®-enabled device that includes Bluetooth® features, such as Bluetooth® Low Energy (BLE). To locate client device 360, the network device 310 may be used to select and perform the optimal locating method to locate the client device 360. The network device 310 may include at least two cores (e.g., first switching device 340 and second switching device 350), each with at least two separate antennas (e.g., first horizontal antenna 342 and first vertical antenna 344 for first switching device 340, and second horizontal antenna 352 and second vertical antenna 354 for second switching device 350). A first core may be used for HADM application, while a second core can be used for either an Internet of Things (IoT) application or for an Angle of Arrival/Angle of Departure (AoA/AoD) method, depending on the mapping of APs in the enterprise. Both cores may have the same phase length at their respective antenna connectors, or at least each core may be phase calibrated to have the same initial phase at their respective antennas. In one example, if a main, locating AP has two or more surrounding APs in its line of sight (LoS), the HADM antenna(s) of the first core (i.e., first horizontal antenna 342 and first vertical antenna 344 for first switching device 340) may be selected based on the antenna polarization of client device 360 (i.e., first vertical antenna 344 of the first switching device 340 will be selected for a vertical antenna of the client device 360 and first horizontal antenna 342 of the first switching device 340 will be selected for a horizontal antenna of the client device 360). The second core of the network device 310 can be used for IoT applications. The locating system may then implement the AP Trilateration locating method to determine the location of the client device based on determined distances of the client device 360 from each of the main AP and the surrounding LOS APs.

In another example, if the main, locating AP does not have two or more surrounding APs in LoS, then the network device 310 may be used to implement HADM on either the first core or the second core to determine a distance of the client device 360 from the main, locating AP. The client device 360 may be located at any position around the main, locating AP that is of the determined distance (i.e., the result may be a circular distance of radius (R) around the main, locating AP, with the radius being the determined distance, that represents the possible positions of the client device 360 in relation to the main, locating AP). Upon determining the distance of the client device 360, the network device 310 may be used to apply at least one of the AoA method or AoD method on at least one core with at least two antennas to determine the direction in receiving or transmitting signals from the client device 360 to the main, locating AP, respectively. In this example, both cores of the network device 310 may be phase calibrated and the antenna polarization on the cores of the network device 310 may be selected to be the same as the antenna polarization of client device 360. Using the circular distance of the client device 360 and at least one of the AoA direction or the AoD direction, the location of the client device 360 may be determined. In this way, network device 310 may be used to determine the location of client device 360 regardless of the environmental surroundings of an AP in the network 300. The network device 310, using an algorithm, may determine and use the optimal locating method of to locate client device 360, depending on the configuration of network 300.

The client device 360 may be connected to a first access point (AP) in the network 300. The network may include one or more APs, including the first AP. A first and second channel frequencies may be selected to use to locate the position of the client device 360 in relation to the first AP. The first and second channel frequencies may be used to send messages or signals between the client device 360 and the first AP. The network device 310 may be used to send messages or signals between the client device 360 and the first AP. The network device 310 may use the first switching device 340 and at least one of the first horizontal antenna 342 and first vertical antenna 344 to send messages or signals between the client device 360 and the first AP at the first channel frequency. The network device 310 may use the second switching device 350 and at least one of the second horizontal antenna 352 and second vertical antenna 354 to send messages or signals between the client device 360 and the first AP at the second channel frequency.

Upon selecting the first channel frequency, which can be any frequency number that both the client device 360 and the first AP may both use, the second channel frequency may be selected based on the first channel frequency and a frequency difference threshold between the first and second channel frequencies. The frequency difference threshold may be between 2 MHz and 78 MHz. The frequency difference threshold may be preset. The frequency different threshold may be based on one or more attributes of the client device 360, the first AP, network 300, or any combination thereof. The frequency difference between BLE channels may be in steps of 2 MHz. The actual frequency difference (i.e., delta of channel frequencies) between the first and the second channel frequencies may be any value between 2 MHz and 78 MHz.

The second channel frequency may be selected further based on a resolution threshold. The resolution threshold may be a maximum margin of error permitted in determining a distance of a device. If the resolution threshold is 5 cm, then the actual resolution may be any value up to 5 cm. As an example, a resolution threshold may be 5 cm, indicating that a determined distance of the client device 360 from the first AP may have a margin of error of up to 5 cm. If a determined distance of the client device 360 from the first AP is 40 cm, then the actual distance of the client device 360 may be between 35 cm to 45 cm with the resolution threshold of 5 cm. The actual frequency difference between the first and second channel frequencies may determine the actual resolution to be used in determining the distance of the client device 360 from the first AP. The resolution threshold may be present. The resolution threshold may be based on one or more attributes of the client device 360, the first AP, network 300, or any combination thereof. The resolution threshold may be present. Many variations are possible.

The delta of channel frequencies between the first and second channel frequencies may influence the range of distance between the client device 360 and the first AP that is permitted in order to be able to determine the exact location of the client device 360 in relation to the first AP. For example, the lower the delta of channel frequencies (i.e., the first and second channel frequencies are closer in numbers), the greater the distance allowed between the client device 360 and the first AP in order to locate the position of the client device 360 in relation to the first AP. In addition, the greater the delta of channel frequencies (i.e., the first and second channel frequencies are farther in numbers), the lower the distance allowed between the client device 360 and the first AP in order to locate the position of the client device 360 in relation to the first AP. If the client device 360 is not at a distance within the distance allowed based on the delta of channel frequencies, the delta of channel frequencies may need to be decreased (i.e., by adjusting at least one of the first and second channel frequencies) until the distance of the client device 360 is within the allotted distance allowed. Graph 1 illustrates an example of the relationship between the delta of channel frequencies and the range of distance allowed between a client device and an AP.

The delta of channel frequencies between the first and second channel frequencies may influence the range of resolution (e.g., margin of error) that will be used to determine the exact location of the client device 360 in relation to the first AP. For example, the lower the delta of channel frequencies (i.e., the first and second channel frequencies are closer in numbers), the greater the range of resolution of the distance between the client device 360 and the first AP. This represents that the lower the delta of channel frequencies, the more inaccurate the determination of the location of the client device 360 in relation to the first AP may be. In addition, the greater the delta of channel frequencies (i.e., the first and second channel frequencies are farther in numbers), the lower the range of resolution of the distance between the client device 360 and the first AP. This represents that the greater the delta of channel frequencies, the more accurate the determination of the location of the client device 360 in relation to the first AP may be. Graph 2 illustrates an example of the relationship between the delta of channel frequencies and the range of resolution in determining the location of a client device in relation to an AP.

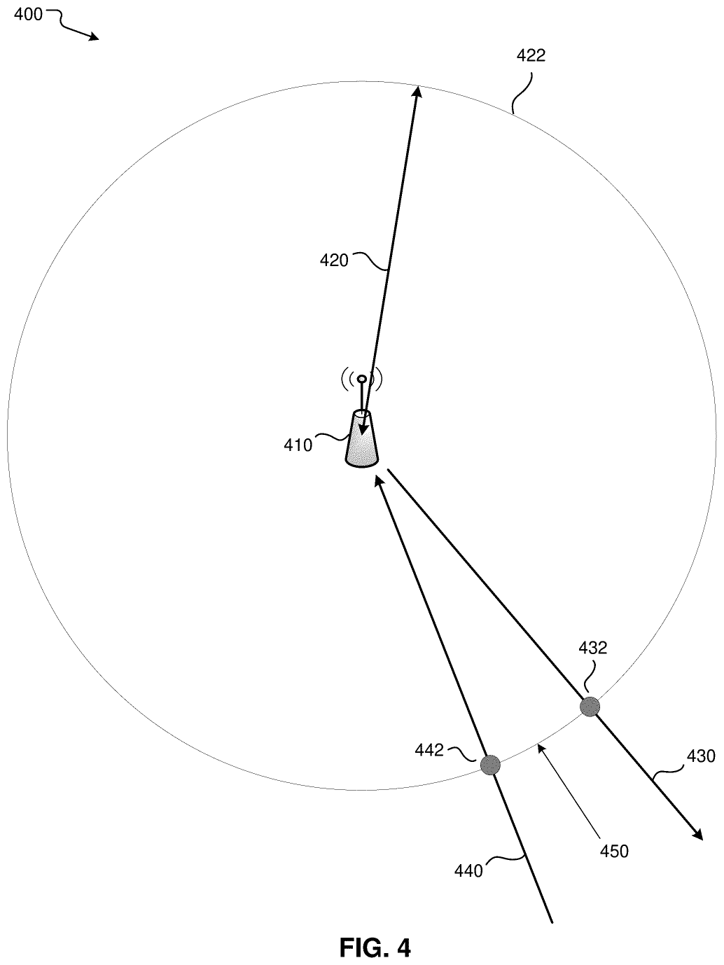

FIG. 4 illustrates an example diagram 400 of performing High Accuracy Distance Measurement (HADM) to determine the location of a client device in a network. A client device may be connected to a first access point (AP), such as AP 410, in a network. The network may include one or more APs, including AP 410. A first and second channel frequencies may be selected to use to locate the position of the client device in relation to AP 410. The first and second channel frequencies may be used to send messages or signals between the client device and AP 410. The location of a client device in relation to AP 410 may be determined irrespective on the number of APs in the network, the number of APs surrounding AP 410, and the number of APs in a line of sight (LoS) to AP 410.

In the example FIG. 4, a method of locating a client device may be performed using a single AP, such as AP 410. This locating method may apply HADM to determine the locating position of a client device based on the single AP. Upon selecting a first and second channel frequencies (as described in detail in FIG. 3), a first and second phase measurements may be determined. In an example, the first phase measurement may be determined according to the first channel frequency, and the second phase measurement may be determined according to the second channel frequency. The first phase measurement may be indicative of a difference between a phase of a signal being received and a phase of a signal being transmitted by the AP 410 with the client device at the first channel frequency. The second phase measurement may be indicative of a difference between a phase of a signal being received and a phase of a signal being transmitted by the AP 410 with the client device at the second channel frequency. Using the first channel frequency and the second channel frequency, a delta of channel frequencies (i.e., frequency difference) may be determined and used to calculate a distance (or an estimated distance) between the client device and the AP 410. Using the first phase measurement and the second phase measurement, a delta of phase measurements (i.e., phase measurement difference) may be determined and used to calculate a distance (or an estimated distance) between the client device and the AP 410. The distance, such as distance 420, between the client device and the AP 410 may be estimated according to the resolution (i.e., margin of error) to be accounted for based on the delta of channel frequencies (as described in detail in FIG. 3 and Graph 2).

Using the delta of channel frequencies (Δf) and the delta of phase measurements (Δφ), a distance 420 of the client device from AP 410 may be determined. The distance 420 of the client device from the AP 410 may be indicative of the amount of space between the client device and AP 410. The distance 420 determined may be an estimation of the actual distance between the client device and the AP 410, based on the resolution to be accounted for according to the delta of channel frequencies. The distance 420(d) may be determined by Equation 1, where c is the speed of light of 3*10⁸ m/s:

$$d = \frac{Δφ c}{4 π Δ f} mod \frac{c}{2 Δ f} \qquad Equation 1$$

Upon determining the distance 420, a location circle 422 may be generated around the AP 410. The location circle 422 may have a radius of the determined distance 420 of the client device, with the AP 410 being at the center of the location circle 422. The location circle 422 may be indicative of all the potential positions of the client device's location with respect to the AP 410 based on the determined distance 420 between the client device and the AP 410.

In one example, an Angle of Arrival (AoA) direction 430 of the client device to the AP 410 may be determined and used to determine the location of the client device. The AoA direction 430 of the client device to the AP 410 may be indicative of the direction or angle that the AP 410 is receiving messages or signals from the client device. The AoA direction 430 may be determined using one of the first or second channel frequencies to receive messages or signals by the AP 410 from the client device. The AP 410 may receive messages or signals from the client device using at least one antenna, such as a first antenna, tuned to one of the first or second channel frequencies (as described in detail FIG. 3).

The AoA direction 430 may be used with the location circle 422 to determine an AoA location 432 on the location circle 422. The AoA location 432 may be the point of intersection of the AoA direction 430 on the location circle 422. The AoA location 432 may be indicative of a potential position of where messages or signals received by the AP 410 from the client device originated. The AoA location 432 may be an estimated position of the client device's location.

In another example, an Angle of Departure (AoD) direction 440 of the client device to the AP 410 may be determined and used to determine the location of the client device. The AoD direction 440 of the client device to the AP 410 may be indicative of the direction or angle that the AP 410 is transmitting messages or signals to the client device. The AD direction 440 may be determined using one of the first or second channel frequencies to transmit messages or signals by the AP 410 from the client device. The AP 410 may transmit messages or signals to the client device using at least one antenna, such as a second antenna, tuned to one of the first or second channel frequencies (as described in detail FIG. 3). The second antenna of the AP 410 may be tuned to the same channel frequency as the first antenna of the AP 410. The second antenna of the AP 410 may be tuned to the channel frequency that is different from the channel frequency tuned for the first antenna of the AP 410. As an example, if the first antenna of the AP 410 is tuned to the first channel frequency to receive messages or signals from the client device, then the second antenna of the AP 410 may be tuned to the second channel frequency to transmit messages or signals to the client device. Many variations are possible.

The AoD direction 440 may be used with the location circle 422 to determine an AoD location 442 on the location circle 422. The AoD location 442 may be the point of intersection of the AoD direction 440 on the location circle 422. The AoD location 442 may be indicative of a potential position of where messages or signals transmitted by the AP 410 to the client device ended. The AoD location 442 may be an estimated position of the client device's location.

Using the location circle 422 and at least one of the AoA location 432 or the AoD location 442, the location of the client device (or estimated location of the client device) may be determined. In one example, as illustrated in FIG. 4, if the AoA method is performed, then the AoA direction 430 may intersect the location circle 422 at the AoA location 432. The AoA location 432 may represent the position on the location circle 422 where the client device received messages or signals from AP 410. The AoA location 432 may be indicative of the location (or estimated location) of the client device. In another example, as illustrated in FIG. 4, if the AoD method is performed, then the AoD direction 440 may intersect the location circle 422 at the AoD location 442. The AoD location 442 may represent the position on the location circle 422 where the client device transmitted messages or signals to AP 410. The AoD location 442 may be indicative of the location (or estimated location) of the client device.

The size of the location circle section 450 may vary (i.e., be smaller or larger). Although not illustrated in FIG. 4, the AoA direction 430 may be on the same axis as the AoD direction 440, leading to the AoA location 432 and the AoD location 442 being at the same position on the location circle 422. If the AoA location 432 and the AoD location 442 are at the same position on the location circle 422, then the AoA/AoD location may be the actual location of the client device. Ideally, the AoA direction 430 and AoD direction 440 may be on the same axis and the AoA/AOD location on the location circle 422 may be the exact location of the client device.

Table 1 is an example of various phase measurement differences and their corresponding distance measurements for a delta of channel frequencies of 8 MHz. Table 1 demonstrates that the distance measurement of a client device from a locating, main AP varies according to the delta of phase measurements. The delta of phase measurements may change according to the selection of the channel frequencies, even though the delta of channel frequencies remains at 8 MHz. Overall, as the delta of phase measurements increases, the distance measurement of the client device from the locating, main AP may also increase.

TABLE 1

| | | Delta of | | |
|---|---|---|---|---|
| Delta of | | channel | Distance | |
| phases | | frequencies | Measurement | Resolution |
| Degrees | Radians | 8 MHz | meters | cm |
| 0 | 0.00 | 8.00E+06 | 0.000 | 5.208 |
| 30 | 0.52 | 8.00E+06 | 1.563 | 5.208 |
| 60 | 1.05 | 8.00E+06 | 3.125 | 5.208 |
| 90 | 1.57 | 8.00E+06 | 4.688 | 5.208 |
| 120 | 2.09 | 8.00E+06 | 6.250 | 5.208 |
| 150 | 2.62 | 8.00E+06 | 7.813 | 5.208 |
| 180 | 3.14 | 8.00E+06 | 9.375 | 5.208 |
| 210 | 3.67 | 8.00E+06 | 10.938 | 5.208 |
| 240 | 4.19 | 8.00E+06 | 12.500 | 5.208 |
| 270 | 4.71 | 8.00E+06 | 14.063 | 5.208 |
| 300 | 5.24 | 8.00E+06 | 15.625 | 5.208 |
| 330 | 5.76 | 8.00E+06 | 17.188 | 5.208 |
| 360 | 6.28 | 8.00E+06 | 18.750 | 5.208 |

This locating method may be performed irrespective of the environmental surroundings of the AP 410 and network configurations. This locating method may be performed when it is determined that a number of APs surrounding the AP 410 is less than two. This locating method may be performed when it is determined that a number of APs surrounding the AP 410 is at least two and of the surrounding APs, less than two are in a line of sight (LoS) of the AP 410. This locating method may be performed irrespective of it being determined that a number of APs surrounding the AP 410 is at least two and of the surrounding APs, at least two are in a LOS of the AP 410. Many variations are possible.

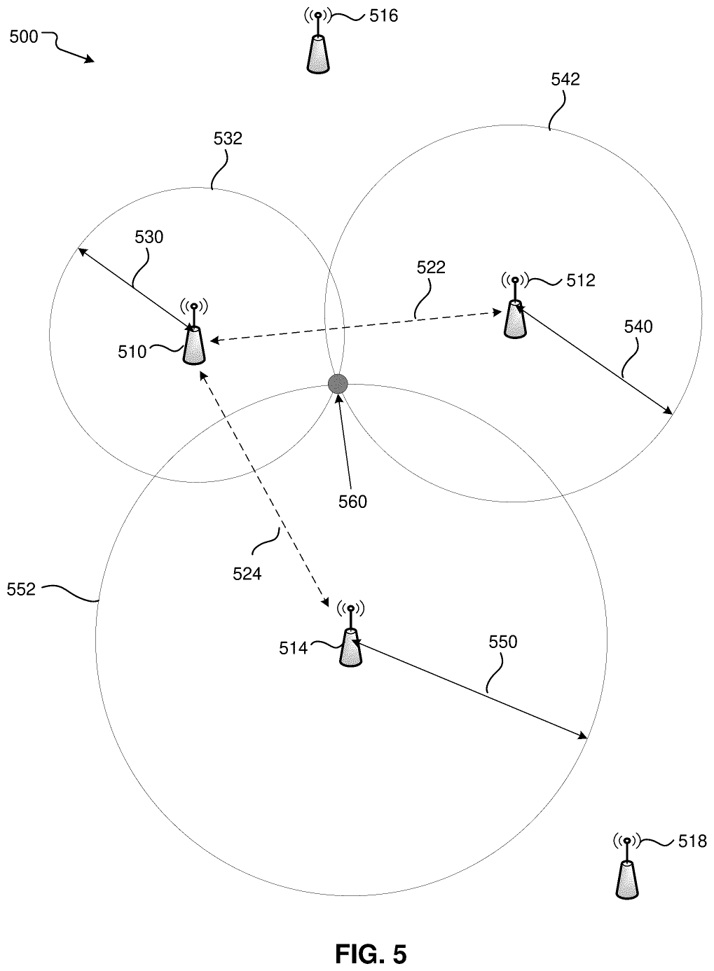

FIG. 5 illustrates an example diagram 500 of performing High Accuracy Distance Measurement (HADM) to determine the location of a client device in a network. A client device may be connected to a first access point (AP), such as AP 510, in a network. The network may include one or more APs, including APs 510, 512, 514, 516, and 518. A first and second channel frequencies may be selected to use to locate the position of the client device in relation to AP 510. The first and second channel frequencies may be used to send messages or signals between the client device and AP 510. The location of a client device in relation to AP 510 may be determined using a plurality of APs in the network, such that there are at least two APs surrounding AP 510 and at least two of the surrounding APs are in a line of sight (LoS) to the AP 510.

In the example FIG. 5, a method of locating a client device may be performed using three APs, such as AP 510, 512, and 514. This locating method may apply HADM to determine the locating position of a client device based on the three APs. Upon determining that the client device is connected to AP 510, the network may be analyzed to determine if there are any APs surrounding AP 510, such as APs 512, 514, 516 and 518. APs in the network may be determined to be surrounding AP 510 when such APs are within a distance threshold from AP 510. Upon determining there are at least two APs surrounding AP 510, such surrounding APs, such as APs 512, 514, 516, and 518, may be analyzed to determine if any are in a LOS to the AP 510. An AP may be in a LOS to the AP 510 when the AP is within a LOS distance threshold relative to AP 510. An AP may be in a LOS to the AP 510 when a line of a straight path between the AP and the AP 510 is physically unobstructed by another network device. An AP may be in a LOS to the AP 510 when a communication line of a straight path between the AP and the AP 510 is unobstructed by signals or messages from another network device. Many variations are possible.

AP 512 may be determined to have a LOS 522 to AP 510. AP 514 may be determined to have a LOS 524 to AP 510. APs 516 and 518 may be determined to not have a LOS to AP 510. Given that at least two surrounding APs of AP 510 are in a LoS to AP 510, this locating method may proceed to determine a plurality of distances of the client device from the main AP connected to the client device (i.e., AP 510) and each of the LoS APs to the main AP (i.e., APs 512 and 514).

Upon determining at least two LOS APs to AP 510, a network device, such as a radio chip, may be used to perform a locating method to locate the client device. The network device may include at least two cores, each with at least two separate antennas. At least one core may be selected to perform HADM to determine a distance of the client device from each of the LoS APs 512 and 514, and AP 510. The antennas of the core of the network device may be selected based on the antenna polarization of the client device. In one example, a vertical antenna of the core of the network device may be selected for a vertical antenna of the client device. In another example, a horizontal antenna of the core of the network device may be selected for a horizontal antenna of the client device.

With the selection of antennas to communicate with the client device, a first and second channel frequencies may be selected (as described in detail in FIG. 3), and a first and second phase measurements for AP 510 may be determined. In an example, the first phase measurement of AP 510 may be determined according to the first channel frequency, and the second phase measurement of AP 510 may be determined according to the second channel frequency. The first phase measurement of AP 510 may be indicative of a difference between a phase of a signal being received and a phase of a signal being transmitted by the AP 510 with the client device at the first channel frequency. The second phase measurement of AP 510 may be indicative of a difference between a phase of a signal being received and a phase of a signal being transmitted by the AP 510 with the client device at the second channel frequency. Using the first channel frequency and the second channel frequency, a delta of channel frequencies (i.e., frequency difference) may be determined and used to calculate a distance (or an estimated distance) between the client device and the AP 510. Using the first phase measurement of AP 510 and the second phase measurement of AP 510, a delta of phase measurements (i.e., phase measurement difference) of AP 510 may be determined and used to calculate a distance (or an estimated distance) between the client device and the AP 510. The distance, such as distance 530, between the client device and the AP 510 may be estimated according to the resolution (i.e., margin of error) to be accounted for based on the delta of channel frequencies (as described in detail in FIG. 3 and Graph 2).

Using the delta of channel frequencies (Δf) and the delta of phase measurements (Aφ) of AP 510, a distance 530 of the client device from AP 510 may be determined. The distance 530 of the client device from the AP 510 may be indicative of the amount of space between the client device and AP 510. The distance 530 determined may be an estimation of the actual distance between the client device and the AP 510, based on the resolution to be accounted for according to the delta of channel frequencies. The distance 530(d) may be determined by Equation 1 (shown above), where c is the speed of light of 3*10⁸ m/s.

Upon determining the distance 530 of the client device in relation to AP 510, a location circle 532 may be generated around the AP 510. The location circle 532 may have a radius of the determined distance 530 of the client device, with the AP 510 being at the center of the location circle 532. The location circle 532 may be indicative of all the potential positions of the client device's location with respect to the AP 510 based on the determined distance 530 between the client device and the AP 510.

The same steps of determining phase measurements, distance, and generating a location circle may be applied for the LoS APs 512 and 514.

Using the first and second channel frequencies previously selected, a third and fourth phase measurements for AP 512 may be determined. In an example, the third phase measurement of AP 512 may be determined according to the first channel frequency, and the fourth phase measurement of AP 512 may be determined according to the second channel frequency. The third phase measurement of AP 512 may be indicative of a difference between a phase of a signal being received and a phase of a signal being transmitted by the AP 512 with the client device at the first channel frequency. The fourth phase measurement of AP 512 may be indicative of a difference between a phase of a signal being received and a phase of a signal being transmitted by the AP 512 with the client device at the second channel frequency. Using the first channel frequency and the second channel frequency, a delta of channel frequencies (i.e., frequency difference) may be determined and used to calculate a distance (or an estimated distance) between the client device and the AP 512. Using the third phase measurement of AP 512 and the fourth phase measurement of AP 512, a second delta of phase measurements (i.e., phase measurement difference) of AP 512 may be determined and used to calculate a distance (or an estimated distance) between the client device and the AP 512. The distance, such as distance 540, between the client device and the AP 512 may be estimated according to the resolution (i.e., margin of error) to be accounted for based on the delta of channel frequencies (as described in detail in FIG. 3 and Graph 2).

Using the delta of channel frequencies (Δf) and the second delta of phase measurements (Aφ) of AP 512, a distance 540 of the client device from AP 512 may be determined. The distance 540 of the client device from the AP 512 may be indicative of the amount of space between the client device and AP 512. The distance 540 determined may be an estimation of the actual distance between the client device and the AP 512, based on the resolution to be accounted for according to the delta of channel frequencies. The distance 540(d) may be determined by Equation 1 (shown above), where c is the speed of light of 3*10⁸ m/s.

Upon determining the distance 540 of the client device in relation to AP 512, a location circle 542 may be generated around the AP 512. The location circle 542 may have a radius of the determined distance 540 of the client device, with the AP 512 being at the center of the location circle 542. The location circle 542 may be indicative of all the potential positions of the client device's location with respect to the AP 512 based on the determined distance 540 between the client device and the AP 512.

Using the first and second channel frequencies previously selected, a fifth and sixth phase measurements for AP 514 may be determined. In an example, the fifth phase measurement of AP 514 may be determined according to the first channel frequency, and the sixth phase measurement of AP 514 may be determined according to the second channel frequency. The fifth phase measurement of AP 514 may be indicative of a difference between a phase of a signal being received and a phase of a signal being transmitted by the AP 514 with the client device at the first channel frequency. The sixth phase measurement of AP 514 may be indicative of a difference between a phase of a signal being received and a phase of a signal being transmitted by the AP 514 with the client device at the second channel frequency. Using the first channel frequency and the second channel frequency, a delta of channel frequencies (i.e., frequency difference) may be determined and used to calculate a distance (or an estimated distance) between the client device and the AP 514. Using the fifth phase measurement of AP 514 and the sixth phase measurement of AP 514, a third delta of phase measurements (i.e., phase measurement difference) of AP 514 may be determined and used to calculate a distance (or an estimated distance) between the client device and the AP 514. The distance, such as distance 550, between the client device and the AP 514 may be estimated according to the resolution (i.e., margin of error) to be accounted for based on the delta of channel frequencies (as described in detail in FIG. 3 and Graph 2).

Using the delta of channel frequencies (Δf) and the third delta of phase measurements (Aφ) of AP 514, a distance 550 of the client device from AP 514 may be determined. The distance 550 of the client device from the AP 514 may be indicative of the amount of space between the client device and AP 514. The distance 550 determined may be an estimation of the actual distance between the client device and the AP 514, based on the resolution to be accounted for according to the delta of channel frequencies. The distance 550(d) may be determined by Equation 1 (shown above), where c is the speed of light of 3*10⁸ m/s.

Upon determining the distance 550 of the client device in relation to AP 514, a location circle 552 may be generated around the AP 514. The location circle 552 may have a radius of the determined distance 550 of the client device, with the AP 514 being at the center of the location circle 552. The location circle 552 may be indicative of all the potential positions of the client device's location with respect to the AP 514 based on the determined distance 550 between the client device and the AP 514.

The location circle 532 of AP 510, the location circle 542 of AP 512, and the location circle 552 of AP 514 may be used to determine the location of the client device. The location of the client device may be the one or more points of intersection of the location circles 532, 542, and 552 (i.e., one or more points of intersection between a location circle of a main AP, a location circle of a first of a set of LoS APs, and a location circle of a second of the set of LOS APs). The location circles 532, 542, and 552 may have various points of intersection at various positions. The various points of intersections may be used to determine an estimated location of the client device, with the estimated location being within the area of space within the various points of intersections. The location circles 532, 542, and 552 may have one point of intersection at one position, such as location position 560. This single point of intersection of location position 560 may be the exact location of the client device. Many variations are possible.

Table 2 is an example of various phase measurement differences and their corresponding distance measurements for a delta of channel frequencies of 10 MHz. Table 2 demonstrates that the distance measurement of a client device from a locating, main AP varies according to the delta of phase measurements. The delta of phase measurements may change according to the selection of the channel frequencies, even though the delta of channel frequencies remains at 10 MHz. Overall, as the delta of phase measurements increases, the distance measurement of the client device from the locating, main AP may also increase.

TABLE 2

| | | Delta of | | |
|---|---|---|---|---|
| Delta of | | channel | Distance | |
| phases | | frequencies | Measurement | Resolution |
| Degrees | Radians | 10 MHz | meters | cm |
| 0 | 0.00 | 1.00E+07 | 0.000 | 4.200 |
| 30 | 0.52 | 1.00E+07 | 1.250 | 4.200 |
| 60 | 1.05 | 1.00E+07 | 2.500 | 4.200 |
| 90 | 1.57 | 1.00E+07 | 3.750 | 4.200 |
| 120 | 2.09 | 1.00E+07 | 5.000 | 4.200 |
| 150 | 2.62 | 1.00E+07 | 6.250 | 4.200 |
| 180 | 3.14 | 1.00E+07 | 7.500 | 4.200 |
| 210 | 3.67 | 1.00E+07 | 8.750 | 4.200 |
| 240 | 4.19 | 1.00E+07 | 10.000 | 4.200 |
| 270 | 4.71 | 1.00E+07 | 11.250 | 4.200 |
| 300 | 5.24 | 1.00E+07 | 12.500 | 4.200 |
| 330 | 5.76 | 1.00E+07 | 13.750 | 4.200 |
| 360 | 6.28 | 1.00E+07 | 15.000 | 4.200 |

This locating method may be performed according to the environmental surroundings of the AP 410 and network configurations. This locating method may be performed when it is determined that there are at least two APs surrounding a main AP connected to the client device, such as AP 510, and of the surrounding APs, at least two are in a LOS of the main AP. According to the network configuration, a network device, such as network device 310 of FIG. 3, may be used to perform a locating method according to FIG. 4 or a locating method according to FIG. 5. In this way, the location of a client device may be determined using the optimal locating method depending on the network configuration.

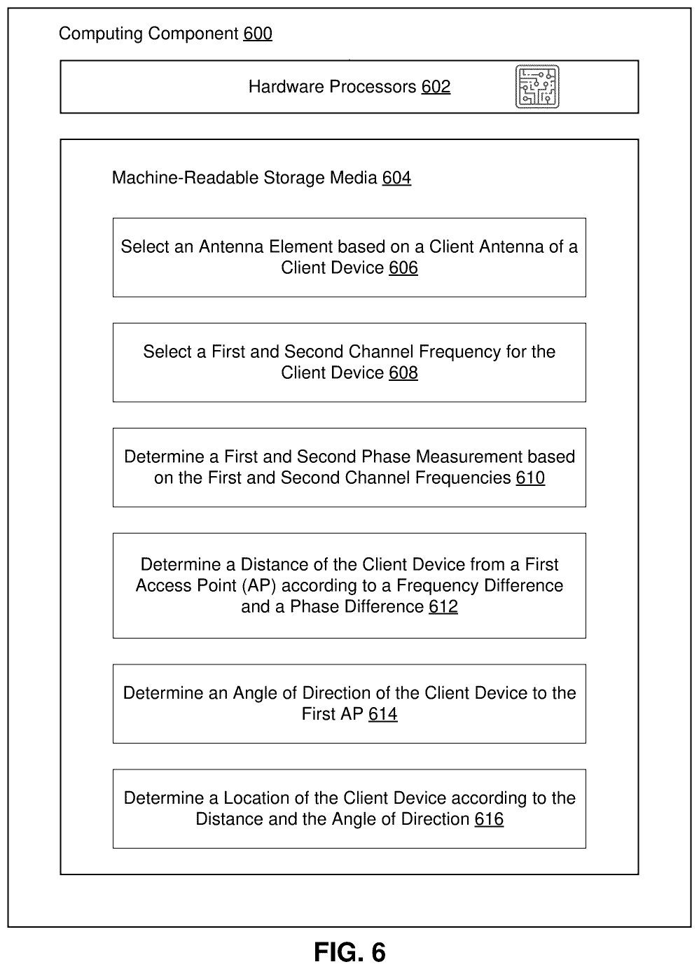

FIG. 6 illustrates a computing component 600 that includes one or more hardware processors 602 and machine-readable storage media 604 storing a set of machine-readable/machine-executable instructions that, when executed, cause the hardware processor(s) 602 to perform an illustrative method for locating a client device by performing High Accuracy Distance Measurement (HADM) using Bluetooth® Low Energy (BLE). It should be appreciated that there can be additional, fewer, or alternative steps performed in similar or alternative orders, or in parallel, within the scope of the various examples discussed herein unless otherwise stated. The computing component 600 may be implemented as the server 111 of FIG. 1, the server 211 of FIG. 2, and the network device 310 of FIG. 3. FIG. 6 summarizes and further elaborates on some aspects previously described.

At step 606, the hardware processor(s) 602 may execute machine-readable/machine-executable instructions stored in the machine-readable storage media 604 to select an antenna element based on a client antenna of a client device. To locate a client device, a network device, such as a radio chip, may be used to perform a locating method to locate the client device. The network device may include at least two cores, each with at least two separate antennas. A first core may be used for HADM application, while a second core can be used for either an Internet of Things (IoT) application or for an Angle of Arrival/Angle of Departure (AoA/AoD) method, depending on the mapping of APs in the enterprise. Both cores may have the same phase length at their respective antenna connectors, or at least each core may be phase calibrated to have the same initial phase at their respective antennas. An algorithm may be used to determine the locating method according to the network configuration and use the network device to perform the locating method to locate a client device.

Antenna(s), i.e., antenna elements, of the first and second cores of the network device may be selected based on the client device's antenna polarization, i.e., a client antenna of the client device. The antenna element may include one or more vertical antennas and one or more horizontal antennas for each core of the network device. For example, vertical antennas of the first core and the second core of the network device may be selected for a vertical antenna of the client device, and horizontal antennas of the first and second cores of the network device may be selected for a horizontal antenna of the client device. Both cores of the network device may be phase calibrated and the antenna polarization on the cores of the network device may be selected to be the same as the client device's antenna polarization.

At step 608, the hardware processor(s) 602 may execute machine-readable/machine-executable instructions stored in the machine-readable storage media 604 to select a first and second channel frequencies for the client device. A client device may be connected to a first access point (AP) in a network. The network may include one or more APs, including the first AP. A first and second channel frequencies may be selected to use to locate the position of the client device in relation to the first AP. The first and second channel frequencies may be used to send messages or signals between the client device and the first AP. Upon selecting the first channel frequency, which can be any frequency number that both the client device and the first AP may both use, the second channel frequency may be selected based on the first channel frequency and a frequency difference threshold between the first and second channel frequencies. The frequency difference threshold may be between 2 MHz and 78 MHz. The frequency difference threshold may be present. The frequency difference threshold may be based on one or more attributes of the client device, first AP, network, or any combination thereof. The frequency difference between BLE channels may be in steps of 2 MHZ. The actual frequency difference between the first and the second channel frequencies may be any value between 2 MHz and 78 MHz.

The second channel frequency may be selected further based on a resolution threshold. The resolution threshold may be a maximum margin of error permitted in determining a distance of a device. If the resolution threshold is 5 cm, then the actual resolution may be any value up to 5 cm. As an example, a resolution threshold may be 5 cm, indicating that a determined distance of a client device from an AP may have a margin of error of up to 5 cm. If a determined distance of a client device from an AP is 40 cm, then the actual distance of the client device may be between 35 cm to 45 cm with a resolution threshold of 5 cm. The actual frequency difference between the first and second channel frequencies may determine the actual resolution to be used in determining the distance of the client device from the first AP. The resolution threshold may be present. The resolution threshold may be based on one or more attributes of the client device, first AP, network, or any combination thereof. The resolution threshold may be present. Many variations are possible.

The second channel frequency may be selected further based on a range threshold. The range threshold may be a minimum range of distance permitted in determining a distance of a device. If the range threshold is 40 cm, then the actual range of distance between a client device and an AP may be any value up to 40 cm. As an example, a range threshold may be 50 cm, indicating that a client device and an AP may be a distance apart of at most 50 cm for the client device's location to be determined. If the actual range of distance between the client device and the AP is greater than 50 cm, then the client device is out of range for the range threshold of 50 cm and the range threshold may need to be adjusted to locate the client device. The actual frequency difference between the first and second channel frequencies may determine the actual range of distance to be used in determining the distance of the client device from the first AP. The range threshold may be present. The range threshold may be based on one or more attributes of the client device, first AP, network, or any combination thereof. Many variations are possible.

At step 610, the hardware processor(s) 602 may execute machine-readable/machine-executable instructions stored in the machine-readable storage media 604 to determine a first and second phase measurements based on the first and second channel frequencies. Upon selecting the first and second channel frequencies, a first and second phase measurements may be determined. The first phase measurement may be determined according to the first channel frequency. The second phase measurement may be determined according to the second channel frequency. Many variations are possible.

The first phase measurement may be indicative of a difference between a phase of a signal being received and a phase of a signal being transmitted by the first AP at the first channel frequency. The second phase measurement may be indicative of a difference between a phase of a signal being received and a phase of a signal being transmitted by the first AP at the second channel frequency. The difference between the first phase measurement and the second phase measurement (i.e., phase measurement difference) may be used to determine a distance (or an estimated distance) between the client device and the first AP.

At step 612, the hardware processor(s) 602 may execute machine-readable/machine-executable instructions stored in the machine-readable storage media 604 to determine a distance of the client device from a first access point (AP) according to a frequency difference and a phase difference. Using the frequency difference between the first and second channel frequencies and the phase difference between the first and second phase measurements, a distance of the client device from the first AP may be determined. The distance of the client device from the first AP may be indicative of the amount of space between the client device and the first AP. The distance determined may be an estimation of the actual distance between the client device and the first AP.

Using the determined distance of the client device, a location circle may be generated around the first AP. The location circle may have a radius of the determined distance of the client device, with the first AP being at the center of the location circle. The location circle may be indicative of all the potential positions of the client device's location with respect to the first AP.

At step 614, the hardware processor(s) 602 may execute machine-readable/machine-executable instructions stored in the machine-readable storage media 604 to determine an angle of direction of the client device to the first AP. An angle of direction of the client device to the first AP may be determined. The angle of direction may be at least one of an angle of arrival (AoA) direction or an angle of departure (AoD) direction of the client device to the first AP.

The AoA direction of the client device to the first AP may be indicative of the direction or angle that the first AP is receiving messages or signals from the client device. The AoA direction may be determined using one of the first or second channel frequencies to receive messages or signals by the first AP from the client device. The first AP may receive messages or signals from the client device using a first antenna tuned to one of the first or second channel frequencies.

The AoD direction of the client device to the first AP may be indicative of the direction or angle that the first AP is transmitting messages or signals to the client device. The AoD direction may be determined using one of the first or second channel frequencies to transmit messages or signals by the first AP to the client device. The first AP may transmit messages or signals to the client device using a second antenna tuned to one of the first or second channel frequencies.

The second antenna of the first AP may be tuned to the same channel frequency as the first antenna of the first AP. The second antenna of the first AP may be tuned to the channel frequency that is different from the channel frequency tuned for the first antenna of the first AP. As an example, if the first antenna of the first AP is tuned to the first channel frequency to receive messages or signals from the client device, then the second antenna of the first AP is tuned to the second channel frequency to transmit messages or signals to the client device.

At step 616, the hardware processor(s) 602 may execute machine-readable/machine-executable instructions stored in the machine-readable storage media 604 to determine a location of the client device according to the distance and the angle of direction. Using the distance and the angle of direction of the client device to the first AP, the location of the client device may be determined. As previously explained, the distance may be used to generate a location circle around the first AP. The location circle may have a radius of the distance and be indicative of all the potential positions of the client device's location with respect to the first AP.

The angle of direction may be used against the location circle to determine an angle of direction location on the location circle. As previously explained, the angle of direction may be at least one of an AoA direction or an AoD direction of the client device to the first AP. If the angle of direction is the AoA direction of the client device to the first AP, then the AoA direction may be used against the location circle to determine an AoA location on the location circle. The AoA location may be the point of intersection of the AoA direction on the location circle. The AoA location may be indicative of a potential position of where messages or signals received by the first AP from the client device originated. The AoA location may be an estimated position of the client device's location. The AoA location may be the angle of direction location.

If the angle of direction is the AoD direction of the client device to the first AP, then the AoD direction may be used against the location circle to determine an AoD location on the location circle. The AoD location may be the point of intersection of the AoD direction on the location circle. The AoD location may be indicative of a potential position of where messages or signals transmitted by the first AP to the client device ended. The AoD location may be an estimated position of the client device's location. The AoD location may be the angle of direction location.

The AoA location and the AoD location may be the same position on the location circle when the AoA direction and the AoD direction are the same. If the AoA location and the AoD location are the same, then the AoA/AOD location is the actual location of the client device. The AoA location and the AoD location may be different positions on the location circle when the AoA direction and the AoD direction are different. If the AoA location and the AoD location are different, then the location of the client device may be at a position on the location circle that is between the AoA location and the AoD location.

This locating method may be performed irrespective of the environmental surroundings of the first AP and network configurations. This locating method may be performed when it is determined that a number of APs surrounding the first AP is less than two. This locating method may be performed when it is determined that a number of APs surrounding the first AP is at least two and of the surrounding APs, less than two are in a line of sight (LoS) of the first AP. This locating method may be performed when it is determined that a number of APs surrounding the first AP is at least two and of the surrounding APs, at least two are in a LoS of the first AP. Many variations are possible.

An alternative locating method may be performed to determine the location of the client device when it is determined that a number of APs surrounding the first AP is at least two and of the surrounding APs, at least two are in a LOS of the first AP. The alternative locating method may select a set of at least two LOS APs. A first and second channel frequencies may be selected to use to locate the position of the client device in relation to the first AP and the set of LoS APs. Using the first and second channel frequencies, a first and second phase measurements may be determined for first AP. Using the first and second channel frequencies, a third and fourth phase measurements may be determined for a first of the set of LoS APs. Using the first and second channel frequencies, a fifth and sixth phase measurements may be determined for a second of the set of LOS APs. A phase difference may be determined for each AP according to the respective AP's phase measurements.

A frequency difference of the first and second channel frequencies and a phase difference of the phase measurements of the first AP may be used to determine a first distance of the client device from the first AP. The first distance may be used to generate a location circle around the first AP. The location circle may have a radius of the first distance and be indicative of all the potential positions of the client device's location with respect to the first AP.

The frequency difference of the first and second channel frequencies and a phase difference of the phase measurements of the first of the set of LOS APs may be used to determine a second distance of the client device from the first of the set of LoS APs. The second distance may be used to generate a location circle around the first of the set of LOS APs. The location circle may have a radius of the second distance and be indicative of all the potential positions of the client device's location with respect to the first of the set of LOS APs.

The frequency difference of the first and second channel frequencies and a phase difference of the phase measurements of the second of the set of LOS APs may be used to determine a third distance of the client device from the second of the set of LOS APs. The third distance may be used to generate a location circle around the second of the set of LOS APs. The location circle may have a radius of the third distance and be indicative of all the potential positions of the client device's location with respect to the second of the set of LOS APs.

The location circles of each AP (i.e., the location circles of the first AP and set of LOS APs) may be used to determine the location of the client device. The location of the client device may be the one or more points of intersection of the location circles of each AP (i.e., the one or more points of intersection between the location circle of the first AP, the location circle of the first of the set of LOS APs, and the location circle of the second of the set of LOS APs). The location circles of each AP may have one point of intersection at one position. This single point of intersection may be the exact location of the client device. The location circles of each AP may have various points of intersection at various positions. The various points of intersections may be used to determine an estimated location of the client device, with the estimated location being within the area of space within the various points of intersections. Many variations are possible.

As alluded to above, examples of the present disclosure are directed to resolving a technical problem in computer technology regarding the limitations for a network to locate device positions. In particular, various methods of locating a client device in a network may be performed under any network configuration and attributes. The various client device locating methods may leverage HADM to locate devices more quickly and accurately. While conventional systems and methods are limited to locating devices under certain network configurations and attributes, examples of the present disclosure allow client devices to be located in a network irrespective of the network configuration and settings, allowing client devices to be more easily identified and communication connections to be more easily established between devices. Examples of the present disclosure are also able to determine an optimal or preferred device locating method to apply based on network configurations and attributes.

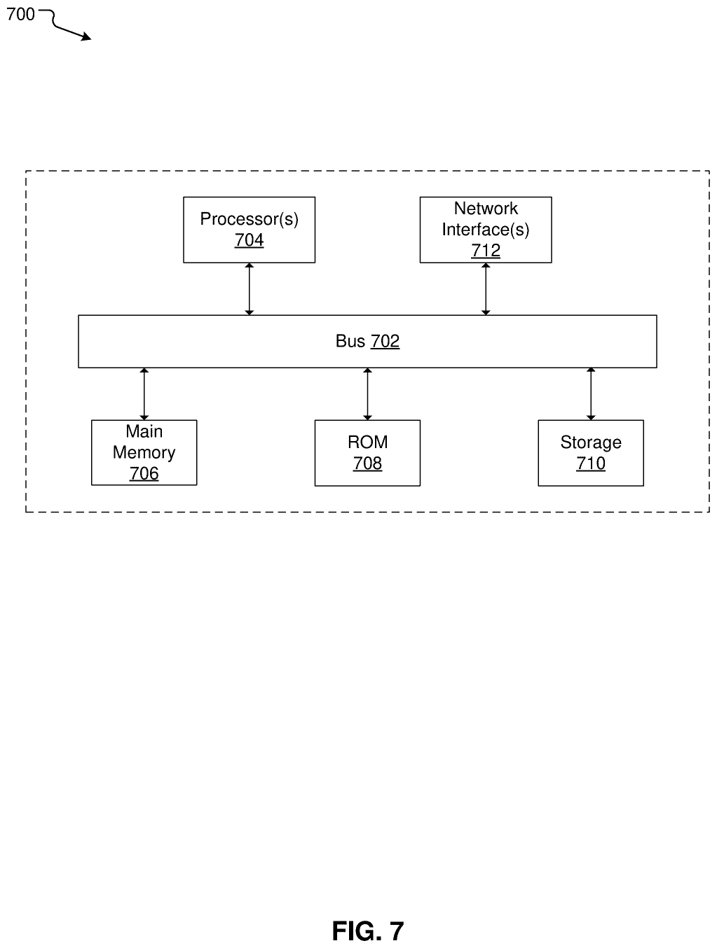

FIG. 7 illustrates a block diagram of an example computer system 700 in which various of the examples described herein may be implemented. For example, the functionality of one or more of the elements, network functions, etc. illustrated in any of FIGS. 1-6 may be implemented or effectuated by computer system 700. The computer system 700 can include a bus 702 or other communication mechanism for communicating information, one or more hardware processor(s) 704 coupled with bus 702 for processing information. Hardware processor(s) 704 may be, for example, one or more general purpose microprocessors. The computer system 700 may be an example of a network device, an access point (AP), or similar device. The computer system 700 may use the bus 702 and the hardware processor(s) 704 to perform operations or transfer instructions. For example, processor 704 may transmit a request via bus 702 to access instructions stored in memory 706 or ROM 708 to select a first and second channel frequencies for a client device, determine a first and second phase measurements, determine a distance of the client device, determine an angle of arrival (AoA) direction of the client device, determine an angle of departure (AoD) direction of the client device, and determine a location of the client device. In another example, processor 704 may transmit a request via bus 702 to access instructions stored in memory 706 or ROM 708 to determine a set of line of sight (LOS) APs to a first AP, select a first and second channel frequencies for a client device, determine a plurality of distances between the client device and each of the APs, and determine a location of the client device. Various operations may be transmitted via bus 702 without diverting from the essence of the disclosure.

The computer system 700 may also include a main memory 706, such as a random access memory (RAM), cache and/or other dynamic storage devices, coupled to bus 702 for storing information and instructions to be executed by hardware processor(s) 704. Main memory 706 may also be used for storing temporary variables or other intermediate information during execution of instructions to be executed by the hardware processor(s) 704. Such instructions, when stored in storage media accessible to hardware processor(s) 704, render computer system 700 into a special-purpose machine that is customized to perform the operations specified in the instructions. The instructions may comprise, for example, select a first and second channel frequencies for a client device, determine a first and second phase measurements, determine a distance of the client device, determine an AoA direction of the client device, determine an AoD direction of the client device, and determine a location of the client device.

The computer system 700 may further include a read only memory (ROM) 708 or other static storage device coupled to the bus 702 for storing static information and instructions for hardware processor(s) 704. A storage device 710, such as a magnetic disk, optical disk, or USB thumb drive (Flash drive), etc., can be provided and coupled to bus 702 for storing information and instructions. The ROM 708 and storage device 710 may store information, such as, for example, attributes of client devices, a resolution threshold, a range threshold, connectivity list of client devices, locations of client devices, etc. The ROM 708 and storage device 710 may store information and instructions to perform operations. The operations may comprise, for example, select a first and second channel frequencies for a client device, determine a first and second phase measurements, determine a distance of the client device, determine an AoA direction of the client device, determine an AoD direction of the client device, and determine a location of the client device.

The computing system 700 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “modules,” “engine,” “system,” “database,” and the like, as used herein, can refer to logic embodied in hardware or firmware, or to a collection of software instructions, possibly having entry and exit points, written in a programming language, such as, for example, JAVA®, C or C++. A software component may be compiled and linked into an executable program, installed in a dynamic link library, or may be written in an interpreted programming language such as, for example, BASIC, Perl, or PYTHON®. It will be appreciated that software components may be callable from other components or from themselves, and/or may be invoked in response to detected events or interrupts. Software components configured for execution on computing devices, such as the computing system 700, may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 700 may implement the techniques or technology described herein using customized hard-wired logic, one or more ASICs or FPGAs, firmware and/or program logic which in combination with the computer system 700 that causes or programs computer system 700 to be a special-purpose machine. According to one example, the techniques herein may be performed by computer system 700 in response to the hardware processor(s) 704 executing one or more sequences of one or more instructions contained in main memory 706. Such instructions may be read into main memory 706 from another storage medium, such as storage device 710. Execution of the sequences of instructions contained in main memory 706 can cause the hardware processor(s) 704 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media can include, for example, optical or magnetic disks, such as storage device 710. Volatile media can include dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media can participate in transferring information between non-transitory media. For example, transmission media can include coaxial cables, copper wire and fiber optics, including the wires that comprise bus 702. Transmission media can also take the form of acoustic or light waves, such as those generated during radio-wave and infra-red data communications.

Computer system 700 can further include at least one network interface 712, such as a network interface controller module (NIC), network adapter, or the like, or a combination thereof, coupled to the bus 702 for connecting the computer system 700 to at least one network. Network interface 712 may provide a two-way data communication coupling to one or more network links that are connected to one or more local networks. For example, network interface 712 may be an integrated services digital network (ISDN) card, cable modem, satellite modem, or a modem to provide a data communication connection to a corresponding type of telephone line. As another example, network interface 712 may be a local area network (LAN) card to provide a data communication connection to a compatible LAN (or WAN component to communicate with a WAN). Wireless links may also be implemented. In any such implementation, network interface 712 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the worldwide packet data communication network now commonly referred to as the “Internet.” Local network and Internet both use electrical, electromagnetic or optical signals that carry digital data streams. The signals through the various networks and the signals on network link and through network interface 712, which carry the digital data to and from computer system 700, are example forms of transmission media.

The computer system 700 can send messages and receive data, including program code, through the network(s), network link and network interface 712. In the Internet example, a server might transmit a requested code for an application program through the Internet, the ISP, the local network and the network interface 712. The received code may be executed by processor 704 as it is received, and/or stored in storage device 710, or other non-volatile storage for later execution. The network interface 712 may be used to receive and transmit messages one or more client devices to determine the location of each client device using HADM. Various communications are illustrated throughout the disclosure.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 700.

These and other various forms of computer readable media may be involved in carrying one or more sequences of one or more instructions to a processing device for execution. Such instructions embodied on the medium, are generally referred to as “instructions” or “code.” Instructions may be grouped in the form of computer programs or other groupings. When executed, such instructions may enable a processing device to perform features or functions of the present application as discussed herein.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A computer-implemented method for locating a client device in a network using Bluetooth® Low Energy (BLE), the method comprising:
selecting an antenna element based on a client antenna of the client device, wherein the antenna element comprises vertical and horizontal;
selecting a first and second channel frequencies for the client device;
determining a first and second phase measurements based on the first and second channel frequencies;
determining a distance of the client device from a first access point (AP) according to a frequency difference and a phase difference;
determining an angle of direction of the client device to the first AP, the angle of direction comprising:
an angle of arrival (AoA) direction of the client device to the first AP; or
an angle of departure (AoD) direction of the client device to the first AP; and
determining a location of the client device according to the distance and the angle of direction.

2. The computer-implemented method of claim 1, further comprising, prior to the selecting the first and second channel frequencies for the client device, determining a number of surrounding APs to the first AP is less than two.

3. The computer-implemented method of claim 1, further comprising, prior to the selecting the first and second channel frequencies for the client device:
determining a number of surrounding APs to the first AP is at least two; and
determining a second number of Line of Sight (LoS) APs from the number of surrounding APs is less than two.

4. The computer-implemented method of claim 1, wherein the client device is connected to the first AP.

5. The computer-implemented method of claim 1, wherein the frequency difference is the difference between the first and the second channel frequencies.

6. The computer-implemented method of claim 1, wherein the frequency difference is at least 2 MHz and at most 78 MHz.

7. The computer-implemented method of claim 1, wherein the phase difference is the difference between the first and the second phase measurements.

8. The computer-implemented method of claim 1, wherein the second channel frequency is selected according to the first channel frequency, a resolution threshold, and a range threshold.

9. The computer-implemented method of claim 8, wherein the resolution threshold is a maximum margin of error permitted to determine the distance of the client device and is based on one or more attributes of the client device.

10. The computer-implemented method of claim 8, wherein the range threshold is a minimum range of distance permitted to determine the distance of the client device and is based on one or more attributes of the client device.

11. The computer-implemented method of claim 1, wherein the antenna element comprises a first antenna and the AoA direction is based on messages received by the first antenna of the first AP from the client device.

12. The computer-implemented method of claim 1, wherein the antenna element comprises a second antenna and the AoD direction is based on messages transmitted by the second antenna of the first AP to the client device.

13. The computer-implemented method of claim 1, wherein the determining the location of the client device according to the distance and the angle of direction comprises:
generating a location circle with a radius of the distance of the client device around the first AP, wherein the location circle is indicative of potential locations of the client device with respect to the first AP; and
determining an angle of direction location on the location circle, wherein:
the angle of direction location is an AoA location on the location circle based on the AoA direction of the client device to the first AP; or
the angle of direction location is an AoD location on the location circle based on the AoD direction of the client device to the first AP.

14. A computing system for locating a client device in a network using Bluetooth® Low Energy (BLE) comprising:
one or more processors; and
a non-transitory computer readable medium including instructions that, when executed by the one or more processors, cause the one or more processors to perform operations of:
selecting an antenna element based on a client antenna of the client device, wherein the antenna element comprises vertical and horizontal;
selecting a first and second channel frequencies for the client device;
determining a first and second phase measurements based on the first and the second channel frequencies;
determining a distance of the client device from a first access point (AP) according to a frequency difference and a phase difference;
determining an angle of direction of the client device to the first AP, the angle of direction comprising:
an angle of arrival (AoA) direction of the client device to the first AP; or
an angle of departure (AoD) direction of the client device to the first AP; and
determining a location of the client device according to the distance and the angle of direction by:
generating a location circle with a radius of the distance of the client device around the first AP, wherein the location circle is indicative of potential locations of the client device with respect to the first AP; and
determining an angle of direction location on the location circle, wherein:
the angle of direction location is an AoA location on the location circle based on the AoA direction of the client device to the first AP; or
the angle of direction location is an AoD location on the location circle based on the AoD direction of the client device to the first AP.

15. The computing system of claim 14, wherein the instructions further cause the one or more processors to perform operations comprising, prior to the selecting the first and second channel frequencies for the client device, determining a number of surrounding APs to the first AP is less than two.

16. The computing system of claim 14, wherein the instructions further cause the one or more processors to perform operations comprising, prior to the selecting the first and second channel frequencies for the client device:
determining a number of surrounding APs to the first AP is at least two; and
determining a second number of Line of Sight (LOS) APs from the number of surrounding APs is less than two.

17. The computing system of claim 14, wherein:
the antenna element comprises a first and second antennas;
the AoA direction is based on messages received by the first antenna of the first AP from the client device; and
the AoD direction is based on messages transmitted by the second antenna of the first AP to the client device.

18. A non-transitory storage medium storing instructions that, when executed by at least one processor of a computing system, cause the computing system to perform a method comprising:
determining a set of Line of Sight (LoS) access points (APs) closest to a first AP connected to a client device;
selecting a first and second channel frequencies for the client device;
determining a plurality of distances between the client device and each of the first AP and the set of LOS APs according to the first and the second channel frequencies; and
determining a location of the client device according to the plurality of distances.

19. The non-transitory storage medium of claim 18, wherein the operations further comprise, prior to determining a set of LOS APs that are closest to the first AP connected to the client device:
determining a number of surrounding APs to the first AP is at least two; and
determining a second number of LoS APs from the number of surrounding APs is at least two.

20. The non-transitory storage medium of claim 18, wherein the determining the plurality of distances comprises:
determining a first and second phase measurements for each of the first AP and the set of LoS APs based on the first and the second channel frequencies; and
determining each of the plurality of distances for each of the first AP and the set of LoS APs according to a frequency difference and a respective phase difference of each AP, wherein the frequency difference is the difference between the first and the second channel frequencies and the respective phase difference is the difference between the first and the second phase measurements for the respective AP.
